(19) United States
(12) Patent Application Publication
(10) Pub. No.: US 2017/0245118 A1
(43) Pub. Date: Aug. 24, 2017

(54) MOBILE PHONE CASE WITH WIRELESS INTERCOM

(71) Applicant: REAL TECHNOLOGY INC., SUWANEE, GA (US)

(72) Inventor: SHENGHUA HONG, SUWANEE, GA (US)

(73) Assignee: REAL TECHNOLOGY INC.

(21) Appl. No.: 15/049,135

(22) Filed: Feb. 21, 2016

(51) Int. Cl. H04W 4/06; H04B 1/3888; H04W 72/08; H04M 1/02; H04W 72/02

(52) U.S. Cl. CPC H04W 4/06; H04M 1/0249; H04M 1/0262; H04M 1/0266; H04W 72/02; H04W 72/085; H04B 1/3888

(57) ABSTRACT

A mobile phone case comprising an external cover to cover a mobile phone, a control module coupled to the external cover and a wireless intercom module coupled to the control module to provide wireless communications independent of a state of the mobile phone.

### BACKGROUND

(1) Technical

The present disclosure relates to mobile phones and more specifically to mobile phones having wireless intercoms.

(2) Background

Cell phones are at the heart of the communications expansion that has encompassed the known world. Many countries have forgone building a land line infrastructure in favor of a cellular infrastructure. Many of these countries have cell phone utilized in remote areas that may be far from a cellular tower. Currently, if a cellular tower cannot be communicated with the cell phones cannot be used to communicate. One possible solution to the current communication limitation may be to include a wireless intercom functions on the cell phone, so that even if it is out of range of a cellular tower, it may still be used for communication.

### SUMMARY OF THE INVENTION

In one embodiment a mobile phone case comprising an external cover to cover a mobile phone, a control module coupled to the external cover and a wireless intercom module coupled to the control module to provide wireless communications independent of a state of the mobile phone.

In a further embodiment a mobile phone case comprising an external cover to cover a mobile phone, a control module coupled to the external cover, a wireless intercom module coupled to the control module to provide wireless communications independent of a state of the mobile phone, a movable antenna coupled to the external cover and coupled to the wireless intercom module and a charge port coupled to the mobile phone and to the control module.

In yet another embodiment a method of controlling a wireless intercom enabled mobile phone case comprising receiving a base station power level of a cellular signal, receiving a Wi-Fi power level of a Wi-Fi signal, receiving a wireless intercom power level of a wireless intercom signal, selecting one of the cellular signal, the Wi-Fi signal and the wireless intercom signal for a communication channel and transceiving a voice signal on the selected communication channel.

The details of one or more embodiments of the invention are set forth in the accompanying drawings and the description below. Other features, objects, and advantages of the invention will be apparent from the description and drawings, and from the claims.

### DESCRIPTION OF THE DRAWINGS

FIG. 1 is the first illustrative drawing of exterior structure in accordance with one embodiment of the disclosure.

FIG. 2 is the second illustrative drawing of exterior structure in accordance with one embodiment of the disclosure.

FIG. 3 is the third illustrative drawing of exterior structure in accordance with one embodiment of the disclosure.

FIG. 4 is the fourth illustrative drawing of exterior structure in accordance with one embodiment of the disclosure.

FIG. 5 is the fifth illustrative drawing of exterior structure in accordance with one embodiment of the disclosure.

FIG. 6 is the sixth illustrative drawing of exterior structure in accordance with one embodiment of the disclosure.

FIG. 7 is the block diagram of the circuit principle system in accordance with one embodiment of the disclosure.

FIG. 8 is a method in accordance with one embodiment of the disclosure

Like reference numbers and designations in the various drawings indicate like elements.

### DETAILED DESCRIPTION OF THE INVENTION

The disclosure describes a protective case with an embedded wireless intercom; the case protects mobile phone and includes circuitry allowing a voice call utilizing a wireless intercom. The intercom may be analog, digital or interne protocol enabled. Therefore the disclosure offers a possible solution of extending the use of a communication device beyond that of cellular coverage and may provide communication channels in lieu of cellular communication if intercom communication is preferred.

Mobile phones are used for cellular voice communication. These communications may be based on 2G/3G/4G wireless digital communication signals, a voice call may be between a mobile and another mobile phone or to a land line telephone. Cellular voice and data communications rely on a cellular infrastructure of base stations communicating with mobile phones within the area covered by the base station. In some remote areas, access to a base station may be limited or non-existent, thus precluding cellular communication.

The shell of many mobile phones may be constructed of glass and thin metal sheet that may be easily damaged by drops or collisions. During exercise or working with a mobile phone in the field, it is possible to drop the device or to have a collision. Therefore, mobile phone cases provide effective protection of mobile phones caused by drops or collisions.

Wireless intercoms provide two way communications. Voice calls may be made after setting up two or more intercoms to communicate without a need for cellular or web based support. The wireless intercom may communicate by analog signals and digital signals, the digital signals may be digital enhanced cordless communication enabled, internet compatible enabled or the like.

The instant disclosure provides a mobile phone case that protects the exterior appearance and integrity of a mobile phone while including circuitry to allow voice contact during failure of cellular voice communications. Thus the device depicted provides a mobile phone case with an embedded wireless intercom to protect the mobile phone and to make wireless intercom voice calls.

A mobile phone case is provided in one embodiment having a plastic-rubber cover attached to the upper, lower, left and right sides of the mobile phone to support and protect the mobile phone with apertures provided for cameras and buttons.

A case battery, case charging circuit, wireless intercom module, case interface circuit and case display circuit comprise components of the mobile phone case. After the mobile phone is installed within the case, a wireless intercom call may be made or received after setting up wireless intercom communications, the wireless intercom communications being analog or digital.

In one embodiment a method of coupling wireless intercoms comprises depressing a setup button to launch a link with another wireless intercom to set modes and settings within a coverage area of communication of the wireless intercom. The launch link button may search for other wireless communication devices to link with based on analog or digital matching algorithms.

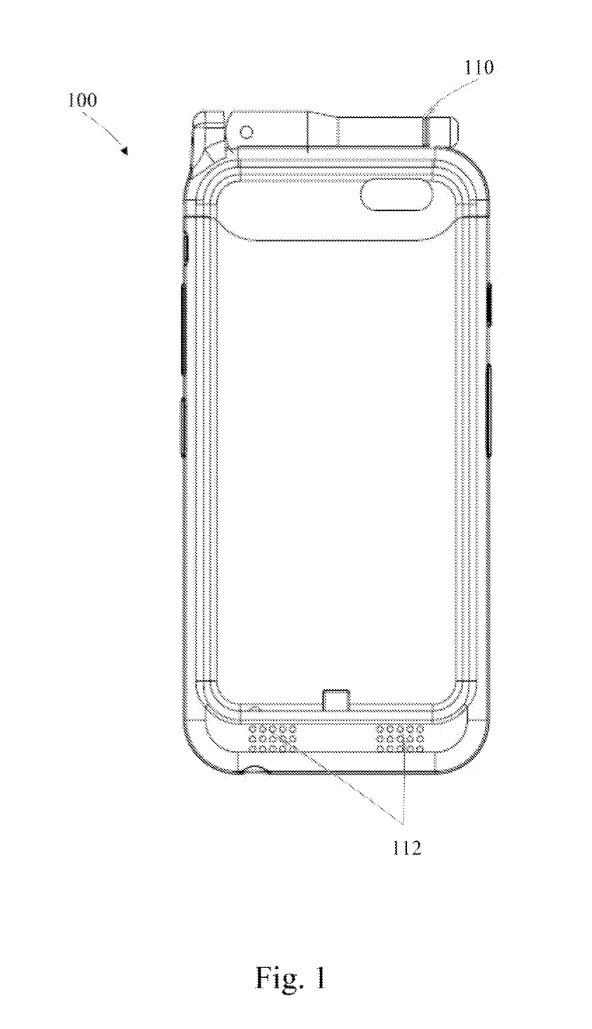

FIG. 1 is the front view of the exterior of the case. The intercom antenna 110 is rotatable, an upward turn of 90 degrees will enhance the sensitive strength of the antenna signal of voice call of the wireless intercom. A loudspeaker 112 is provided in the form of a sound horn for the voice call of the wireless intercom.

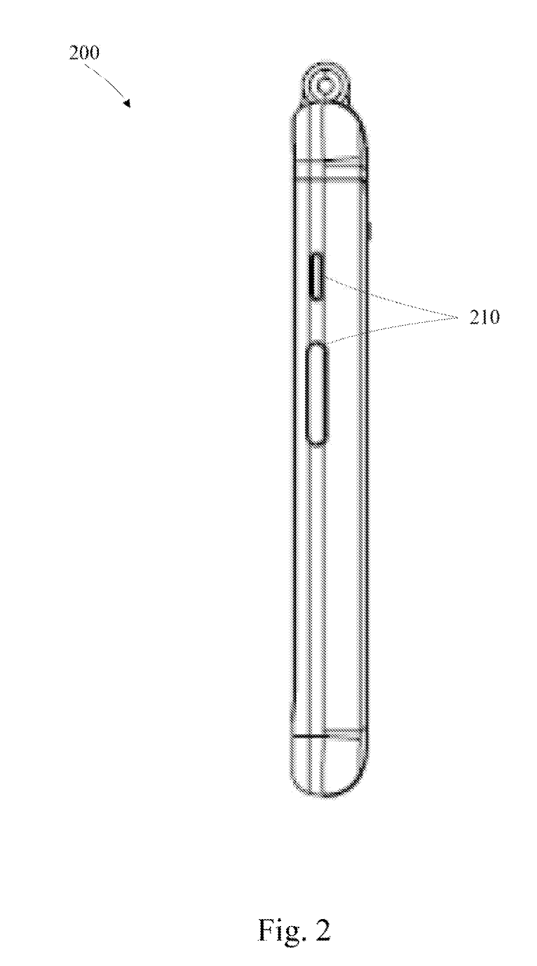

FIG. 2 is the left side view of the exterior appearance of the case showing the control buttons 210.

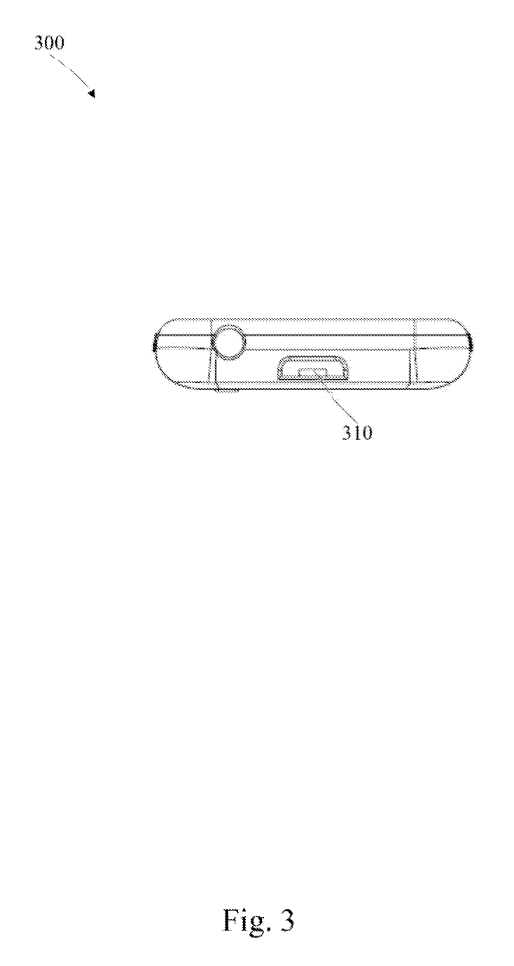

FIG. 3 is the bottom view of the exterior of the case showing a USB charging interface. A micro USB interface 310 is provided to charge the case. Please note that although a micro USB interface is shown any interface may be utilized.

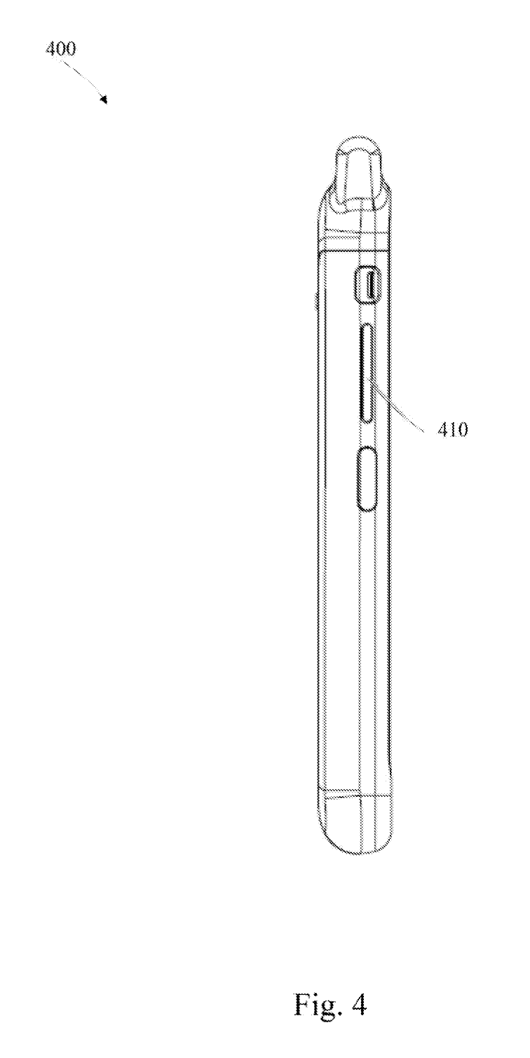

FIG. 4 is the right side view of the exterior of the case showing buttons. A side button 410 is provided to control the status of voice call of the wireless intercom. Pressing a first side button shifts between various calling modes of wireless intercom. Pressing a second side button shifts between various transceiver frequencies of the wireless intercom and the third side button controls a volume.

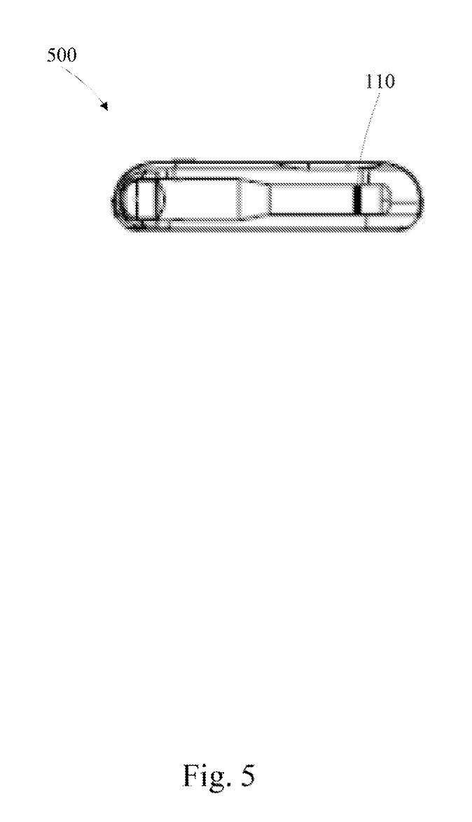

FIG. 5 is the top view of the exterior of the case showing the intercom antenna 110.

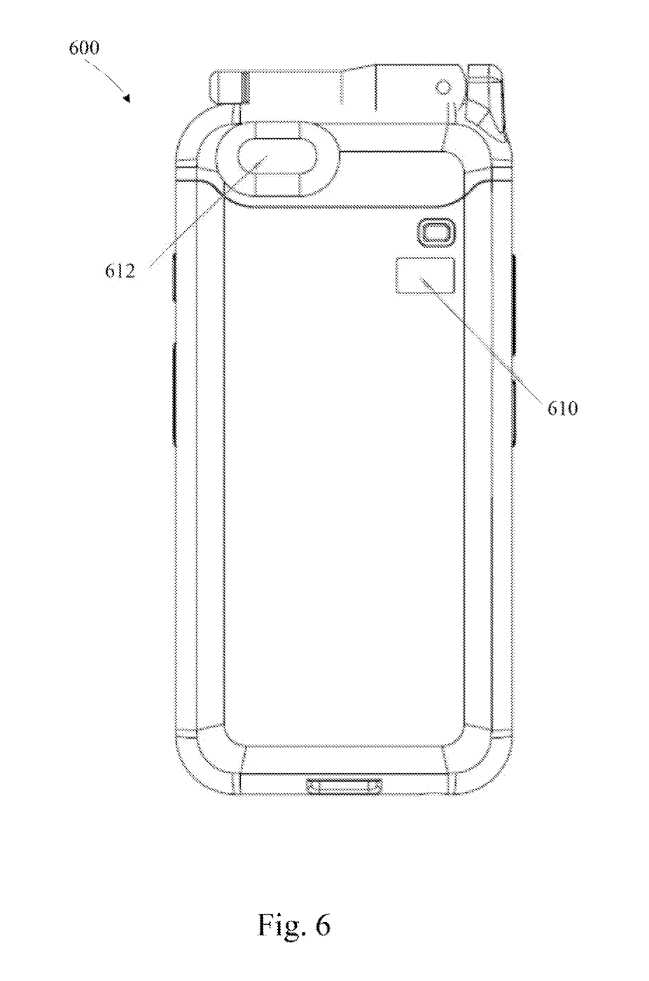

FIG. 6 is the back view of the exterior of the case showing the LCD display. A camera aperture 612 is provided. A mini LCD 610 may show the following information: mode area of calls of wireless intercom call, sending/receiving of wireless intercom call, high/low volume of wireless intercom call, intensity of signal of wireless intercom call, remaining power of battery, current frequency and channel of wireless intercom call and charging status or normal usage status.

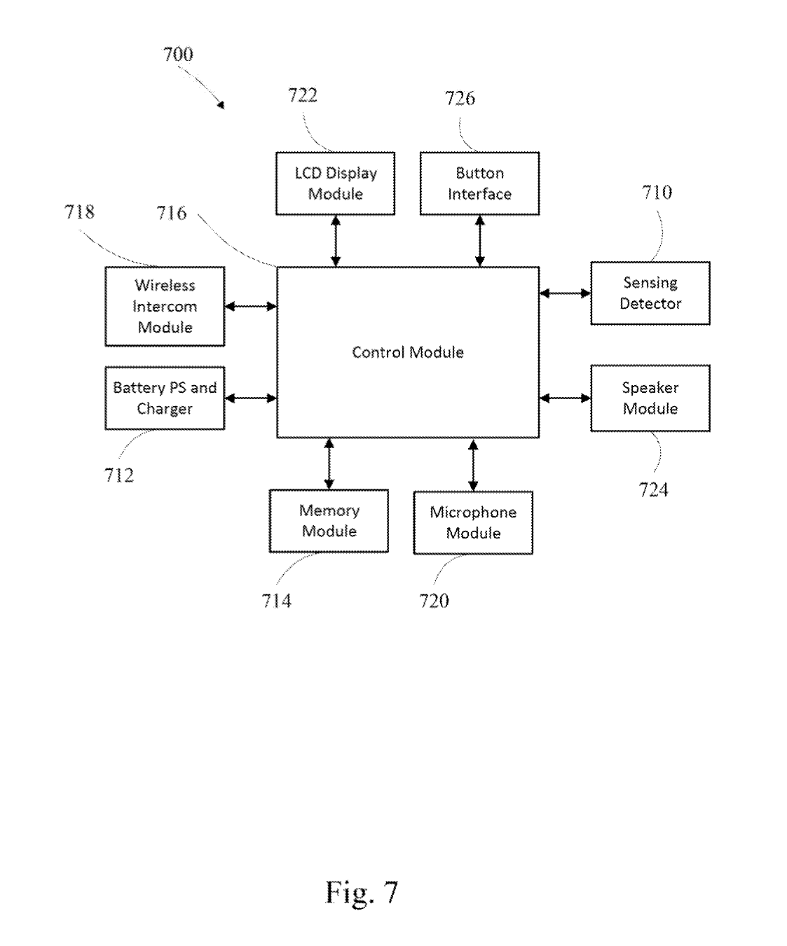

The embodiment as shown in FIG. 7 is the block diagram of the wireless intercom circuit. The apparatus may provide a sensing detection module 710: detecting volume and charging status of the battery, detecting the status of call circuit of wireless intercom for transmission to the control module for judgment and handling.

The apparatus may also comprise a power supply and charging module 712. The charging module may be connected to a battery such as lithium and the like. Power may be supplied to modules controlling wireless intercom call and processor. Charging may be provided via the micro USB external interface.

The apparatus may comprise a memory module 714 to save local program codes and various data, providing control processer module with memory of running operating system and saving relevant parameters and data.

The apparatus may provide a control module 716, such as a high-speed multi-core ARM processor, handling the wireless intercom call via software and programs of operating system, controlling the module circuit of wireless intercom, detecting battery status, controlling charging process, exporting information to LCD display, controlling microphone and speakers of audio input/output path, receiving information of button interface module 726, triggering the handling of corresponding events, and saving corresponding information and data to the memory module.

Signaling and signals received by the wireless control module 718 may be sent to the control module 716 after amplification or may be to the wireless intercom module 718 for modulation and transmission. Parts of the low-frequency signal received after frequency discrimination may enter the control module after amplification and filtering and shaping with band pass filtering of sub-audio frequency for comparison with preset values to enable the result to a control audio amplifier and a speaker output.

The wireless intercom module 718 of the wireless intercom may comprise emitting circuits and receiving circuits of the wireless intercom. A human voice is converted into audio electrical signal via microphone 720, and modulation signals are transmitted from an antenna via transmitting circuit. The signals received from the antenna are demodulated and sent to a receiving circuit. The wireless intercom module may be coupled to a control module which controls interfaces.

The control module may be coupled to an LCD display module 722 having a display interface and driver circuit to control the LCD, displaying simple numbers, characters or letters and indicating the status of battery and wireless intercom call. The wireless intercom module circuit may also be coupled to an interface module such as an on/off, or functional button response, switching and controlling the status, mode, channel and volume of module circuit of wireless intercom. The control module may be coupled to a microphone interface for connecting the microphone to receive a voice input for the wireless intercom The control module may further comprise a speaker interface connected to a speaker module 724 that links the loudspeaker for voice input and output of a wireless intercom call.

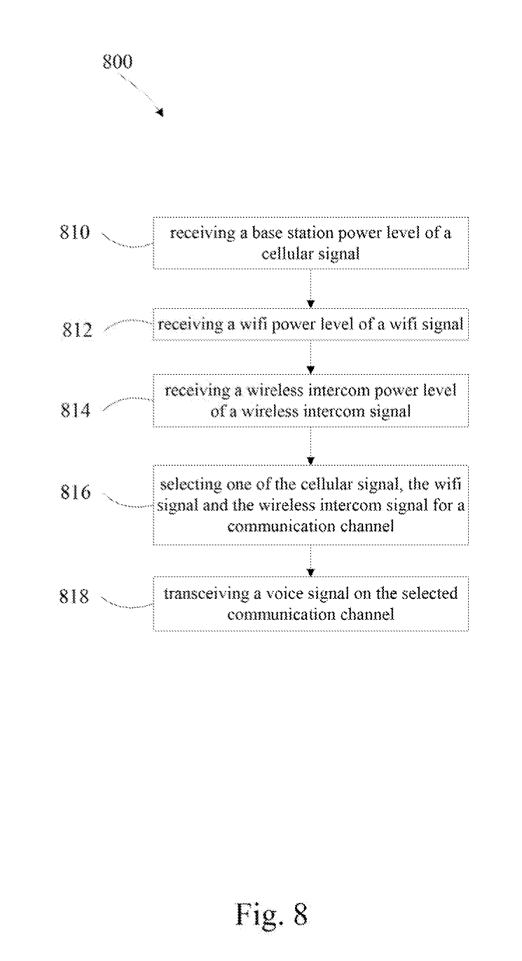

FIG. 8 depicts a method of controlling a wireless intercom enabled mobile phone case comprising receiving 810 a base station power level of a cellular signal, receiving 812 a Wi-Fi power level of a Wi-Fi signal, receiving 814 a wireless intercom power level of a wireless intercom signal, selecting 816 one of the cellular signal, the Wi-Fi signal and the wireless intercom signal for a communication channel and transceiving 818 a voice signal on the selected communication channel. The wireless intercom may be enabled to communicate with analog devices or digital devices that are DECT compliant, IP compliant or the like.

It is to be understood that various modifications may be made without departing from the spirit and scope of the invention. It is to be understood that the foregoing description is intended to illustrate and not to limit the scope of the invention, which is defined by the scope of the following claims, and that other embodiments are within the scope of the claims.

1. A mobile phone case comprising:
an external cover to cover a mobile phone;
a control module coupled to said external cover; and
a wireless intercom module coupled to said control module to provide wireless communications independent of a state of said mobile phone, wherein said wireless communications of said wireless intercom sets modes and settings for two or more intercoms linked within a coverage area based on analog matching or digital matching.

2. The mobile phone case of claim 1 wherein said control module is a processor.

3. The mobile phone case of claim 1 further comprising a battery coupled to said control module.

4. The mobile phone case of claim 3 further comprising a charge port coupled to said battery.

5. The mobile phone case of claim 3 further comprising a charging circuit coupled to said control module.

6. The mobile phone case of claim 1 further comprising a liquid crystal display coupled to said external cover and coupled to said control module to provide a status.

7. The mobile phone case of claim 1 further comprising a memory module coupled to said control module.

8. The mobile phone case of claim 1 further comprising a charge port interface coupled to said mobile phone to allow powering of said control module and said wireless intercom module via said mobile phone.

9. The mobile phone case of claim 1 wherein said wireless intercom module is at least one of analog and digital.

10. The mobile phone case of claim 1 further comprising an antenna coupled to said wireless intercom module.

11. A mobile phone case comprising:
an external cover to cover a mobile phone;
a control module coupled to said external cover;
a wireless intercom module coupled to said control module to provide wireless communications independent of a state of said mobile, wherein said wireless communications of said wireless intercom sets modes and settings for two or more intercoms linked within a coverage area based on analog matching or digital matching;
a movable antenna coupled to said external cover and coupled to said wireless intercom module; and
a charge port coupled to said mobile phone and to said control module.

12. The mobile phone case of claim 11 wherein said control module is an ARM processor.

13. The mobile phone case of claim 11 further comprising a liquid crystal display coupled to said external cover and coupled to said control module to provide a status.

14. The mobile phone case of claim 11 further comprising a memory module coupled to said control module.

15. The mobile phone case of claim 11 wherein said wireless intercom module is at least one of analog, digital and internet protocol enabled.

16. A method of controlling a wireless intercom enabled mobile phone case comprising:
receiving a base station power level of a cellular signal;
receiving a Wi-Fi power level of a Wi-Fi signal;
receiving a wireless intercom power level of a wireless intercom signal;
selecting one of the cellular signal, the Wi-Fi signal and the wireless intercom signal for a communication channel, wherein said wireless communications of said wireless intercom sets modes and settings for two or more intercoms linked within a coverage area based on analog matching or digital matching; and
transceiving a voice signal on the selected communication channel.

17. The method of controlling the wireless intercom enabled mobile phone case of claim 16 further comprising receiving power from said mobile phone.

18. The method of controlling the wireless intercom enabled mobile phone case of claim 17 wherein said selection is based on a user preference.

19. The method of controlling the wireless, intercom enabled mobile phone case of claim 16 wherein said selection is based on the strengths of the cellular signal, the Wi-Fi signal and the wireless intercom signal.

20. The method of controlling the wireless intercom enabled mobile phone case of claim 16 wherein said cellular signal, Wi-Fi signal and wireless intercom signal are one of analog and digital.
